(19) United States
(12) Patent Application Publication
(10) Pub. No.: US 2013/0202920 A1
(43) Pub. Date: Aug. 8, 2013

(54) Dendrite-Inhibiting Salts in Electrolytes of Energy Storage Devices

(71) Applicants: Wu Xu, Richland, WA (US); Fei Ding, Richland, WA (US); Jiguang Zhang, Richland, WA (US); Gordon L. Graff, West Richland, WA (US); Jie Xiao, Richland, WA (US)

(72) Inventors: Wu Xu, Richland, WA (US); Fei Ding, Richland, WA (US); Jiguang Zhang, Richland, WA (US); Gordon L. Graff, West Richland, WA (US); Jie Xiao, Richland, WA (US)

(73) Assignee: BATTELLE MEMORIAL INSTITUTE, Richland, WA (US)

(21) Appl. No.: 13/367,508

(22) Filed: Feb. 7, 2012

(51) Int. Cl. H01M 10/056

(52) U.S. Cl. 429/50; 429/188; 429/199; 429/300

(57) ABSTRACT

The performance and the lifetime of energy storage devices can be hindered by the growth of metal dendrites during operation. Electrolytes having dendrite-inhibiting additives can result in significant improvement. In particular, energy storage devices having an electrode containing a metallic element, M1 can be characterized by a non-aqueous, liquid electrolyte having a first salt and a dendrite-inhibiting salt. The first salt can have a cation of M1 and the dendrite-inhibiting salt can have a cation of metallic element, M2, wherein the cation of M2 has an ionic size greater than, or equal to, the cation of M1.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

In certain energy storage devices, the growth of dendrites on one or more electrodes can lead to decreased performance and/or device lifetime. In but one example, lithium dendrite growth on an electrode of a rechargeable lithium battery can cause a short circuit between conductive elements in the battery. Furthermore, the dendrites can negatively alter the morphology of the electrode on which they form, which can increase the impedance of the whole cell. Therefore, improved energy storage devices having dendrite-inhibiting qualities are needed.

### SUMMARY

Embodiments of the present invention include a salt distributed in the non-aqueous, liquid electrolyte of an energy storage device in order to inhibit dendrite growth, thereby improving the performance, safety, and/or lifetime of the device.

The present invention encompasses an energy storage device having an electrode comprising a metallic element, M1. The device is characterized by a non-aqueous, liquid electrolyte comprising a first salt and a dendrite-inhibiting salt. The first salt comprises a cation of M1 and the dendrite-inhibiting salt comprises a cation of metallic element, M2, wherein the cation of M2 has an ionic size greater than, or equal to, the cation of M1.

In a preferred embodiment, the difference between the electrochemical reduction potential of the cation of M2 and that of the cation of M1 is between zero and 2 volts, inclusive. As used herein, the electrochemical reduction potential refers to a measure of the tendency of a chemical species to acquire electrons and thereby be reduced.

Examples of M1 can include, but are not limited to, Li, Na, K, Mg, Ca, Zn, Al, Cu, Si, Fe, and In. In a preferred embodiment, M1 is Li. One example of an anion of the first salt is PF₆⁻. Additional examples of anions can include, but are not limited to, AsF₆⁻, BF₄⁻, BF₃Cl⁻, ClO₄⁻, I⁻, Br⁻, bis(oxalate)borate (BOB⁻), ⁻N(SO₂F)₂, ⁻N(SO₂R_{F})₂, ⁻N(SO₂F)SO₂R_{F}, and R_{F}SO₃^{-, where R}_{F} is a perfluoroalkyl or perfluoroaryl group.

In some embodiments, wherein M1 is Li, M2 is preferably, K, Rb, Cs, or combinations thereof. In a particular embodiment, the anion of the dendrite-inhibiting salt is PF₆⁻. In another embodiment, the anion of the dendrite-inhibiting salt is not an imide or a perfluoroalkylsulfate.

The dendrite-inhibiting salt can have a concentration that is less than 2 M in the electrolyte. Preferably, the concentration is less than 0.5 M. Exemplary non-aqueous, liquid electrolytes can comprise aprotic organic solvents including but not limited to carbonates, carboxylates, ethers, glymes, sulfoxides, sulfones, phosphates, ionic liquids, such as propylene carbonate (PC), ethylene carbonate (EC), butylene carbonate (BC), dimethyl carbonate (DMC), ethyl methyl carbonate (EMC), dimethyl carbonate (DEC), 1,2-dimethoxyethane (DME), 1,3-dioxolane (DOL), tetrahydrofuran (THF), di(ethylene glycol) dimethyl ether (diglyme), tri(ethylene glycol) dimethyl ether (triglyme), di(ethylene glycol) dibutyl ether (butyl diglyme), dimethyl sulfoxide (DMSO), 1-ethyl-3-methylimidazolium hexafluorophosphate (EMIm-PF₆), 1-ethyl-3-methylimidazolium tetrafluoroborate (EMIm-BF₄), 1-ethyl-3-methylimidazolium bis(trifluoromethylsulfonyl)imide (EMIm-TFSI), 1-butyl-3-methylimidazolium hexafluorophosphate (BMIm-PF₆), 1-butyl-3-methylimidazolinium bis(trifluoromethylsulfonyl)imide (BMIm-TFSI), 1-butyl-1-methylpyrrolinium hexafluorophosphate (Pyr14-PF₆), 1-butyl-1-methylpyrrolinium bis(trifluoromethylsulfonyl)imide (Pyr14-TFSI), 1-methyl-1-propylpiperidinium hexafluorophosphate (Pip13-PF₆), 1-methyl-1-propylpiperidinium bis(trifluoromethylsulfonyl)imide (Pip13-TFS1), and combinations thereof. In one embodiment, the non-aqueous, liquid electrolyte can be a solution and the dendrite-inhibiting salt is at least partially soluble in the electrolyte. In another embodiment, the liquid electrolyte is a gel.

In preferred embodiments, the device further comprises a solid-electrolyte interphase (SEI) layer on the electrode. The SEI layer can comprise an alloy of M1 and M2. In some instances, the alloy can comprise a co-precipitate of the cations of M1 and M2.

The present invention also encompasses a method of inhibiting dendrite formation on an electrode comprising a metallic element, M1. The method is characterized by the steps of distributing a dendrite-inhibiting salt in an electrolyte that is in contact with the electrode. The electrolyte comprises a first salt, which comprises a cation of M1, and the dendrite-inhibiting salt, which comprises a cation of metallic element, M2. The cation of M2 has an ionic size greater than, or equal to, the cation of M1. In some embodiments, the method can further comprising co-precipitating the cations of M1 and M2 onto the electrode, thereby forming a solid-electrolyte interphase layer comprising an alloy of M1 and M2.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 includes an SEM micrograph of the surface of lithium deposited on Cu using a control electrolyte comprising 1.0 M LiPF₆ in PC.

FIG. 2 is a plot comparing the Coulombic efficiency of Li/Cu cells for repeated deposition/stripping cycles in various electrolytes encompassed by embodiments of the present invention.

FIG. 3 includes an SEM micrograph of the surface of lithium deposited on Cu using an electrolyte comprising 0.15 M KPF₆ and 1.0 M LiPF₆ in PC.

FIG. 4 includes an SEM micrograph of the surface of lithium deposited on Cu using an electrolyte comprising 0.15 M NaPF₆ and 1.0 M LiPF₆ in PC.

FIG. 5 includes an SEM micrograph of the surface of lithium deposited on Cu using an electrolyte comprising 0.05 M RbPF₆ and 1.0 M LiPF₆ in PC.

FIG. 6 includes an SEM micrograph of the surface of lithium deposited on Cu using an electrolyte comprising 0.10 M RbPF₆ and 1.0 M LiPF₆ in PC.

FIG. 7 includes an SEM micrograph of the surface of lithium deposited on Cu using an electrolyte comprising 0.05 M CsPF₆ and 1.0 M LiPF₆ in PC.

FIG. 8 includes an SEM micrograph of the surface of lithium deposited on Cu using an electrolyte comprising 0.10 M CsPF₆ and 1.0 M LiPF₆ in PC.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

Development of rechargeable metal batteries can be hindered by growth of metal dendrites during repeated charging and discharging cycles. The dendrites can cause internal short circuiting. Continuous growth of solid electrolyte interface (SEI) layer on the metal anode during cycling is another problem, which consumes the electrolyte, increases the internal resistance of the battery, lowers the Coulombic efficiency of each cycle and shortens the battery life. The formation of irreversible mossy metal in the anode will also reduce the capacity of the battery. These problems can occur in almost any metal battery, and have prevented the practical applications of lithium metal, in particular, in secondary batteries during the last few decades.

Embodiments of the present invention include energy storage devices having a metallic element (M1) in an electrode and an electrolyte comprising ions of M1 as well as a dendrite-inhibiting salt. The dendrite-inhibiting salt comprises a cation of a metallic element (M2) that can improve battery performance by apparently stabilizing the metal electrode and helping to maintain a uniform electrode surface during charging and discharging cycles.

The experiments and descriptions below demonstrate aspects of the present invention through a number of embodiments that use lithium as a metal electrode (M1) and that include a variety of electrolyte compositions and/or battery configurations. Some of the salts used as dendrite-inhibiting salt additives or co-salts in the non-aqueous electrolytes include potassium hexafluorophosphate (KPF₆), rubidium hexafluorophosphate (RbPF₆) and cesium hexafluorophosphate (CsPF₆). Sodium hexafluorophosphate (NaPF₆), lithium bis(trifluoromethanesulfonyl)imide (LiTFSI), potassium bis(trifluoromethanesulfonyl)imide (KTFSI), lithium trifluoromethanesulfonate (CF₃SO₃Li) and potassium trifluoromethanesulfonate (CF₃SO₃K) were also used for comparison.

Many of the salts used and described below were synthesized in the lab. Lithium hexafluorophosphate (LiPF₆), LiTFSI, propylene carbonate (PC) and dimethyl carbonate (DMC) were acquired commercially in battery grade. CF₃SO₃Li (99.995%) was also acquired commercially. KPF₆ (99.9%) and NaPF₆ (99%+) were dried under vacuum and then stored inside a glove box filled with purified argon. RbPF₆, CsPF₆ and KTFSI were synthetized according to the procedures described in the following examples. Electrolytes were prepared inside a glove box filled with purified argon, where the moisture and oxygen content was less than 1 ppm.

Cu foil was used as the substrate electrode (10 mm×10 mm) for lithium deposition because Cu foil was more uniform and smoother than lithium foil. Lithium metal was electro-deposited onto Cu substrates from the test electrolytes inside the glove box. Each electro-deposition process was conducted at 0.1 mA/cm² current density for 15 hours. The deposited lithium electrodes were washed with battery-grade anhydrous dimethyl carbonate (DMC) to remove the residual PC solvent and salts, followed by evacuation inside the antechamber of the glove box to thoroughly remove DMC, and then used for different analyses.

The surface morphologies of the deposited lithium electrodes were measured by scanning electron microscopy (SEM) using a JEOL 5900 scanning electron microscope at a working distance of 12 mm and an accelerating voltage of 20 keV.

The cycling efficiency of different electrolytes was measured in CR2032 coin cells including a Cu foil, a glass fiber (500 μm, GF-B), a lithium foil, and 200 μL test electrolyte. The cells were charged (lithium deposition) and discharged (lithium dissolution) on a battery test system. The lithium deposition/stripping current density was 0.5 mA/cm². In every cycle, the charge for deposition process was 2 C/cm² where 1 C stands for 1 Coulomb) and the charge for the stripping process was limited to 1.0 V vs. Li/Li⁺. The cycling efficiency of lithium deposition and stripping was calculated from the ratio of the discharge capacity over the charge capacity.

### Control Experiment

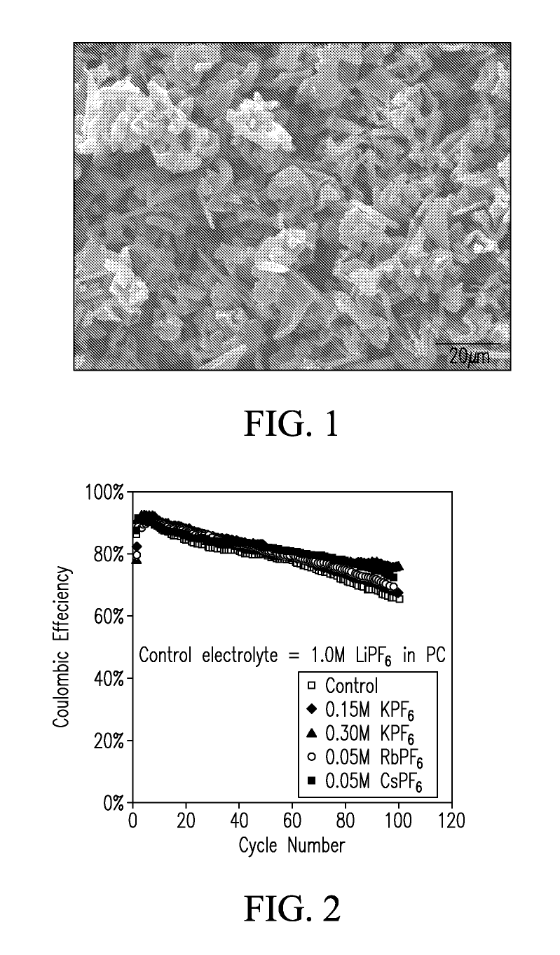

A control electrolyte comprising 1.0 M LiPF₆ in PC was prepared and used to conduct the lithium deposition and cycling efficiency test as described above. FIG. 1 includes an SEM micrograph of the lithium film deposited on the copper substrate using the control electrolyte. FIG. 2 is a plot comparing the Coulombic efficiency of Li/Cu cells for repeated Li deposition/stripping cycling in electrolytes with and without co-salts or salt additives. The addition of KPF₆, RbPF₆ and/or CsPF₆ as dendrite-inhibiting salts improves the long-term Coulombic efficiency of lithium deposition and stripping cycles. The cycling efficiency when using the control electrolyte is shown in FIG. 2 as the “Control” data set. The surface morphology indicates dendrite growth as seen in the micrograph of FIG. 1.

### Experiment 1

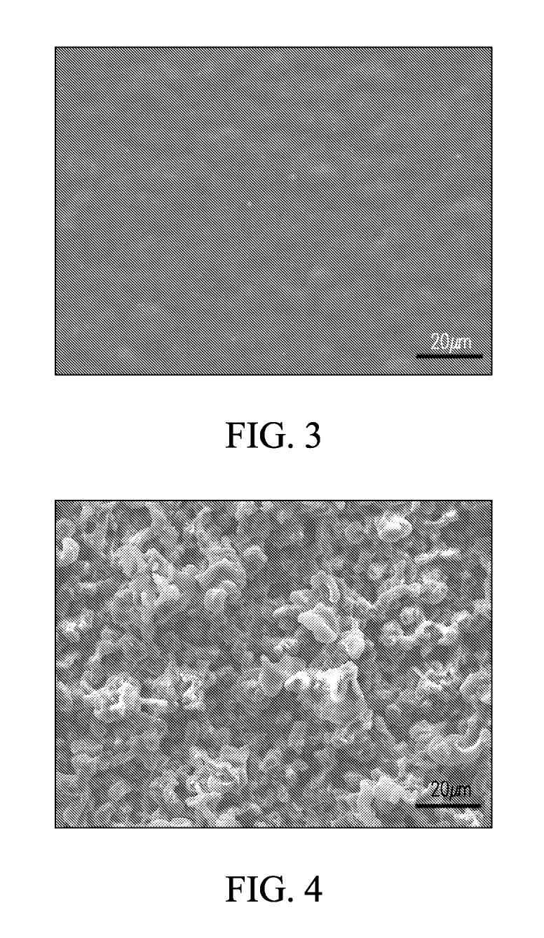

An electrolyte comprising 0.15 M KPF₆ (as the dendrite-inhibiting salt) and 1.0 M LiPF₆ (as the first salt) in PC was prepared and used to conduct the lithium deposition and cycling efficiency test as described above. FIG. 3 includes a SEM micrograph of the lithium film deposited on the copper substrate. The cycling efficiency is shown in FIG. 2 as the “0.15 M KPF₆” data set. FIG. 3 reveals that lithium dendrite is greatly inhibited. The lithium surface morphology is significantly improved and is much smoother than that resulting from Control Experiment. The cycling efficiency is also improved compared to the “Control” data set in FIG. 2. Li deposition curves (not shown) for electrolytes with and without the KPF₆ dendrite-inhibiting salt suggest that the addition of K cations does not significantly affect the lithium deposition. The dendrite-inhibiting salt only increases the deposition potential by approximately 2 mV compared to the control electrolyte, which contains no additive.

### Experiment 2

An electrolyte comprising 0.30 M KPF₆ (as the dendrite-inhibiting salt) and 1.0 M LiPF₆ (as the first salt) in PC was prepared. The cycling efficiency was tested in coin cells and the result is shown in FIG. 2. The cycling efficiency is improved compared with the Control experiment.

### Experiment 3

An electrolyte comprising 0.15 M NaPF₆ (as the dendrite-inhibiting salt) and 1.0 M LiPF₆(as the first salt) in PC was prepared and used to conduct the lithium deposition as described above. FIG. 4 includes a SEM micrograph of the lithium film deposited on the copper substrate. The morphology of lithium deposition is not improved by the addition of NaPF₆ and the surface still exhibits dendrite growth. These results could be attributed to two possible reasons. The first one is Na⁺ ion standard potential (−2.71 vs. SHE) is not as close to Li⁺ (−3.04 V vs. SHE) as K⁺ (−2.93 V vs. SHE), Rb⁺ (−2.98 V vs. SHE) and Cs⁺ (−3.03 V vs. SHE) do, so the state of Na⁺ ion deposited on lithium ion is different from that of other three kinds of ions. The second reason is that Na⁺ ion radius is smaller than that of K⁺, Rb—⁺ and Cs⁺, so when Na⁺ ion is deposited on lithium, it's actions are different from the other three kinds of ions.

### Experiment 4

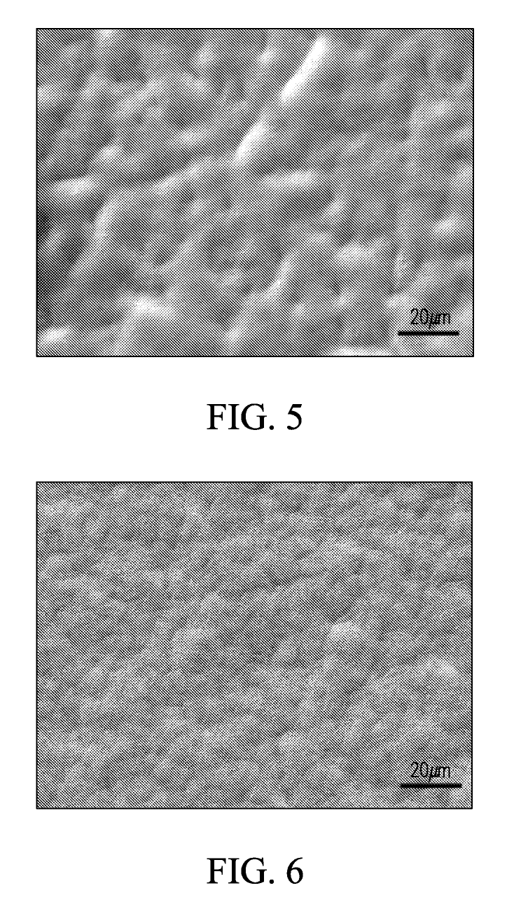

RbPF₆ was prepared by mixing a solution of RbI in PC with AgPF₆ in PC. While the mixed solution was stored overnight inside a glove box, a yellow AgI precipitate formed. The precipitate was filtered off with 0.45 μm syringe filters inside the glove box to yield a solution of RbPF₆ in PC. An electrolyte comprising 0.05 M RbPF₆ (as the dendrite-inhibiting salt) and 1.0 M LiPF₆ (as the first salt) in PC was prepared and used to conduct lithium deposition and cycling efficiency tests as described above. FIG. 5 includes an SEM image of the lithium film deposited on a copper substrate using this electrolyte. The cycling efficiency is shown in plot provided in FIG. 2. Lithium dendrite formation had been inhibited and the surface morphology was significantly improved. The surface is much smoother than those formed by electrolytes without RbPF₆. The cycling efficiency was also improved compared with the “Control” data set in FIG. 2.

### Experiment 5

An electrolyte comprising 0.10 M RbPF₆ (as the dendrite-inhibiting salt) and 1.0 M LiPF₆ (as the first salt) in PC was prepared and used to conduct the lithium deposition as described above. FIG. 6 includes an SEM image of the lithium film deposited on copper substrate using this electrolyte. Lithium dendrite formation was inhibited and the surface morphology was significantly improved. The surface is much smoother than those formed by electrolytes without RbPF₆.

### Experiment 6

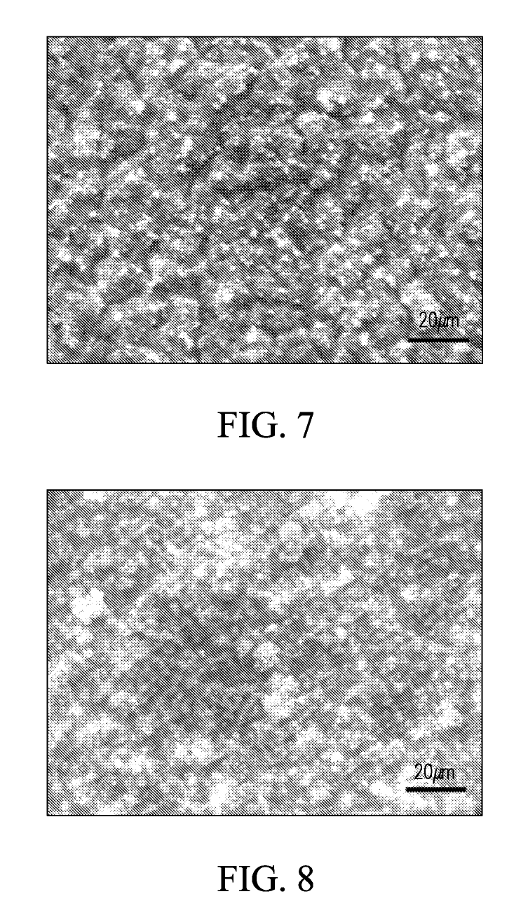

A solution of CsPF₆ in PC was prepared according to a procedure similar to the one described in Experiment 5 using CsI rather than RbI. An electrolyte comprising 0.05 M CsPF₆ (as the dendrite-inhibiting salt) and 1.0 M LiPF₆ (as the first salt) in PC was prepared and used to conduct lithium deposition and cycling efficiency tests as described above. FIG. 7 includes an SEM image of the lithium film deposited on copper substrate using this electrolyte. The cycling efficiency is shown in FIG. 2. Again, lithium dendrite formation was inhibited and the surface was much smoother than those deposited using an electrolyte without CsPF₆. The cycling efficiency was also improved compared with the Control data set in FIG. 2.

### Experiment 7

An electrolyte comprising 0.10 M CsPF₆ (as the dendrite-inhibiting salt) and 1.0 M LiPF₆ (as the first salt) in PC was prepared and used to conduct the lithium deposition as described above. FIG. 8 includes an SEM image of the lithium film deposited on copper substrate using this electrolyte. Lithium dendrite formation was inhibited and the surface morphology was significantly improved. The surface was much smoother than those formed by electrolytes without CsPF₆.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. An energy storage device having an electrode comprising a metallic element, M1, the device characterized by a non-aqueous, liquid electrolyte comprising a first salt and a dendrite-inhibiting salt, the first salt comprising a cation of M1 and the dendrite-inhibiting salt comprising a cation of metallic element, M2, wherein the cation of M2 has an ionic size greater than, or equal to, the cation of M1.

2. The energy storage device of claim 1, wherein a difference between electrochemical reduction potentials of the cation of M2 and the cation of M1 is between zero and 2 volts, inclusive.

3. The energy storage device of claim 1, wherein M1 is Li.

4. The energy storage device of claim 3, wherein M2 is K.

5. The energy storage device of claim 4, wherein the dendrite-inhibiting salt has an anion that is not an imide or a perfluoroalkylsulfate.

6. The energy storage device of claim 3, wherein M2 is Rb.

7. The energy storage device of claim 3, wherein M2 is Cs.

8. The energy storage device of claim 3, wherein the dendrite-inhibiting salt comprises an anion comprising PF₆⁻.

9. The energy storage device of claim 3, wherein the first salt comprises LiPF₆.

10. The energy storage device of claim 1, wherein the dendrite-inhibiting salt has a concentration less than 2 M in the electrolyte.

11. The energy storage device of claim 1, wherein the dendrite-inhibiting salt has a concentration less than 0.5 M in the electrolyte.

12. The energy storage device of claim 1, wherein the liquid electrolyte is a gel.

13. The energy storage device of claim 1, wherein the electrolyte is a solution.

14. The energy storage device of claim 1, wherein M1 is selected from the group consisting of Na, K, Mg, Ca, Zn, Al, Cu, Si, Fe, and In.

15. The energy storage device of claim 1, further comprising a solid-electrolyte interphase (SEI) layer on the electrode, the SEI layer comprising an alloy of M1 and M2.

16. The energy storage device of claim 15, wherein the alloy comprises a co-precipitate of the cations of M1 and M2.

17. An energy storage device having an anode comprising lithium metal, the device characterized by a non-aqueous liquid electrolyte solution comprising a dendrite-inhibiting salt and a soluble lithium salt, the dendrite-inhibiting salt being at least partially soluble in the liquid electrolyte solution and comprising a cation of a metallic element selected from the group consisting of K, Rb, and Cs, wherein the dendrite-inhibiting salt has a concentration less than 0.5 M in the liquid electrolyte solution.

18. The energy storage device of claim 17, further comprising a SEI layer on the anode comprising an alloy of lithium and the metallic element.

19. A method of inhibiting dendrite formation on an electrode comprising a metallic element, M1, the method characterized by the steps of distributing a dendrite-inhibiting salt in an electrolyte that is in contact with the electrode, the electrolyte comprises a first salt comprising a cation of M1 and the dendrite-inhibiting salt comprising a cation of metallic element, M2, wherein the cation of M2 has an ionic size greater than, or equal to, the cation of M1.

20. The method of claim 19, wherein the electrolyte is a non-aqueous liquid.

21. The method of claim 20, wherein the liquid is a gel.

22. The method of claim 20, wherein the liquid is a solution and the dendrite-inhibiting salt is at least partially soluble in the solution.

23. The method of claim 19, wherein the difference between the electrochemical reduction potential of cation of M2 and cation M1 is less than 2 V and larger or equal to zero.

24. The method of claim 19, further comprising co-precipitating the cations of M1 and M2 onto the electrode, thereby forming a solid-electrolyte interphase layer comprising an alloy of M1 and M2.
